(19) United States
(12) Patent Application Publication
(10) Pub. No.: US 2026/0035175 A1
(43) Pub. Date: Feb. 5, 2026

(54) REFUSE COLLECTION VEHICLE ROUTE MANAGEMENT AND OPTIMIZATION

(71) Applicant: The Heil Co., Chattanooga, TN (US)

(72) Inventors: Stanley L. Maroney, Attalla, AL (US); Arturo Islas Rodriguez, Fort Payne, AL (US)

(21) Appl. No.: 19/289,799

(22) Filed: Aug. 4, 2025

Related U.S. Application Data
(60) Provisional application No. 63/679,417, filed on Aug. 5, 2024.

(51) Int. Cl. B65F 3/02; B60L 1/00; B60L 50/60; B60L 58/14; G07C 5/00; G07C 5/08

(52) U.S. Cl. CPC B65F 3/02; B60L 1/00; B60L 50/60; B60L 58/14; G07C 5/008; G07C 5/0825; G07C 5/0833; B60L 2200/40

(57) ABSTRACT

A refuse collection vehicle including a chassis; a cab coupled to a front portion of the chassis; an electric vehicle body coupled to the chassis rearward of the cab, the electric vehicle body including one or more electrically powered body systems the electric vehicle body further including at least one rechargeable battery pack configured to provide electric power to the body systems; at least one rechargeable battery pack configured to provide electric power to the body systems; and a computing device. The computing device is configured to perform operations including: calculating a state-of-charge of at least one rechargeable battery pack based on a voltage of the at least one rechargeable battery pack, determining a remaining capacity of the at least one rechargeable battery pack, and restricting certain electric vehicle body functions when the remaining capacity falls below a threshold.

### CROSS-REFERENCE TO RELATED APPLICATION

This application claims the benefit under 35 U.S.C. § 119(e) of U.S. Patent Application No. 63/679,417, entitled “REFUSE COLLECTION VEHICLE ROUTE MANAGEMENT AND OPTIMIZATION,” filed Aug. 5, 2024, which is incorporated herein by reference in its entirety.

### TECHNICAL FIELD

This disclosure relates to systems and methods for route management and optimization for solid waste collection.

### BACKGROUND

Refuse collection vehicles collect solid waste and transport the solid waste to landfills, recycling centers, or treatment facilities. Historically, refuse collection vehicles have employed diesel powered engines to propel the vehicle and a power takeoff (PTO) that provides hydraulic actuation for vehicle body systems. However, a developing demand for all-electric or partially-electric refuse vehicles has emerged. Improvements in the systems and methods for route management and optimization for solid waste collection, using all-electric or partially-electric refuse vehicles, are continually sought.

### SUMMARY

Implementations of the present disclosure are generally directed to refuse collection vehicles, systems, and methods to manage and optimize refuse collection vehicle routes using all-electric or partially-electric vehicles. More particularly, implementations of the present disclosure are directed to systems and methods configured to perform operations to determine a remaining capacity of a battery pack of a refuse collection vehicle and, based on the remaining capacity, restrict certain electric vehicle body functions when the remaining capacity reaches or falls below a threshold.

In an example implementation, a refuse collection vehicle includes: a chassis; a cab coupled to a front portion of the chassis; an electric vehicle body coupled to the chassis rearward of the cab, the electric vehicle body including one or more electrically powered body systems; at least one rechargeable battery pack configured to provide electric power to the body systems; and a computing device configured to perform operations including: calculating a state-of-charge of the at least one rechargeable battery pack based on a voltage of the at least one rechargeable battery pack, determining a remaining capacity of the at least one rechargeable battery pack, and restricting certain electric vehicle body functions when the remaining capacity falls below a threshold.

In some embodiments, the electric vehicle body includes one or more of an electrically-actuated tailgate, an electrically-actuated lift assembly, and an electrically-actuated refuse packing assembly.

In some embodiments, restricting certain electric vehicle body functions includes decreasing a speed of one or both of the electrically-actuated lift assembly and the electrically-actuated refuse packing assembly.

In some embodiments, decreasing the speed of the electrically-actuated lift assembly includes one or both of decreasing a speed at which an arm of the electrically-actuated lift assembly is lifted and decreasing a speed at which the arm is extended.

In some embodiments, the computing device is configured to generate a visual alert or an audible alert when the remaining capacity falls below the threshold.

In some embodiments, the threshold is determined adaptively.

In some embodiments, the computing device is an onboard computing device of the refuse collection vehicle.

In some embodiments, the refuse collection vehicle includes a display device within the cab, and the computing device is configured to display image data including one or both of the state-of-charge of the at least one rechargeable battery pack, and the remaining capacity of the at least one rechargeable battery pack.

In some embodiments, the computing device is configured to transmit the image data to one or more remote computing devices for display.

In some embodiments, the computing device is configured to perform operations further including: based on the remaining capacity, calculating a remaining number of refuse containers that can be collected on a refuse collection route.

In some embodiments, the computing device is configured to perform operations further including: comparing the remaining number of refuse containers that can be collected to a planned number of refuse containers to be collected, determining if the planned number of refuse containers to be collected exceeds the remaining number of refuse containers that can be collected, and restricting certain electric vehicle body functions when the planned number of refuse containers to be collected exceeds the remaining number of refuse containers that can be collected.

In some embodiments, the computing device is configured to generate a visual alert or an audible alert when the planned number of refuse containers to be collected exceeds the remaining number of refuse containers that can be collected.

In some embodiments, the refuse collection vehicle includes a display device within the cab, and the computing device is configured to display image data including the remaining number of refuse containers that can be collected on a refuse collection route.

In some embodiments, the at least one rechargeable battery pack is mounted on the electric vehicle body.

In some embodiments, the at least one rechargeable battery pack is mounted on the chassis.

In some embodiments, the at least one rechargeable battery pack is a traction battery.

In an aspect combinable with the example implementation, a system includes: a refuse collection vehicle, including: a chassis; a cab coupled to a front portion of the chassis; an electric vehicle body coupled to the chassis rearward of the cab, the electric vehicle body including one or more electrically powered body systems; and at least one rechargeable battery pack configured to provide electric power to the body systems; and at least one processor communicably coupled to the electric vehicle body and the at least one rechargeable battery pack, the at least one processor configured to perform operations including: calculating a state-of-charge of the at least one rechargeable battery pack based on a voltage the at least one rechargeable battery pack, determining a remaining capacity of the at least one rechargeable battery pack, and restricting certain electric vehicle body functions when the remaining capacity falls below a threshold.

In another aspect combinable with any of the previous aspects, a computer-implemented method performed by at least one processor includes: calculating, by the at least one processor, a state-of-charge of at least one rechargeable battery pack of a refuse collection vehicle based on a voltage of the at least one rechargeable battery pack; determining, by the at least one processor, a remaining capacity of the at least one rechargeable battery pack; and restricting, by the at least one processor, certain functions of an electric vehicle body of the refuse collection vehicle when the remaining capacity falls below a threshold.

In some embodiments, the electric vehicle body includes one or more of an electrically-actuated tailgate, an electrically-actuated lift assembly, and an electrically-actuated refuse packing assembly.

In some embodiments, restricting certain electric vehicle body functions includes decreasing a speed of one or both of the electrically-actuated lift assembly and the electrically-actuated refuse packing assembly.

In some embodiments, decreasing the speed of the electrically-actuated lift assembly includes one or both of decreasing a speed at which an arm of the electrically-actuated lift assembly is lifted and decreasing a speed at which the arm is extended.

In some embodiments, the computer-implemented method further includes generating, by the at least one processor, a visual alert or an audible alert when the remaining capacity falls below the threshold.

In some embodiments, the threshold is determined adaptively.

In some embodiments, the computer-implemented method further includes displaying, by the at least one processor, on a display device within a cab of the refuse collection vehicle, image data including one or both of the state-of-charge of the at least one rechargeable battery pack and the remaining capacity of the at least one rechargeable battery pack.

In some embodiments, transmitting, by the at least one processor, the image data to one or more remote processors for display.

In some embodiments, the computer-implemented method further includes calculating, by the at least one processor, based on the remaining capacity, a remaining number of refuse containers that can be collected on a refuse collection route.

In some embodiments, the computer-implemented method further includes comparing, by the at least one processor, the remaining number of refuse containers that can be collected to a planned number of refuse containers to be collected, determining, by the at least one processor, if the planned number of refuse containers to be collected exceeds the remaining number of refuse containers that can be collected, and restricting, by the at least one processor, certain electric vehicle body functions when the planned number of refuse containers to be collected exceeds the remaining number of refuse containers that can be collected.

In some embodiments, the computer-implemented method further includes generating, by the at least one processor, a visual alert or an audible alert when the planned number of refuse containers to be collected exceeds the remaining number of refuse containers that can be collected.

In some embodiments, the computer-implemented method further includes displaying, by the at least one processor, on a display device within a cab of the refuse collection vehicle, image data including the remaining number of refuse containers that can be collected on a refuse collection route.

Particular implementations of the subject matter described in this specification can be implemented so as to realize one or more of the following advantages.

For example, the systems, methods, and refuse collection vehicles of the present disclosure can advantageously determine a capacity of a battery pack of a refuse collection vehicle in real time. The refuse collection vehicles, systems, and methods of the disclosure can accomplish this by calculating a state-of-charge (SOC) of the battery pack based on continuous voltage measurements. Furthermore, the refuse collection vehicles, systems, and methods of the disclosure can optimize and manage the power of a refuse collection vehicle by using a processor or a computing device to determine a remaining capacity of the battery pack and to restrict certain functions of the refuse collection vehicle if the remaining capacity reaches or falls below a threshold, thereby conserving power.

In addition, the refuse collection vehicles, systems, and methods of the disclosure can alert the operator of the refuse collection vehicle if the remaining battery capacity is not sufficient to power the refuse collection vehicle through completion of a refuse collection vehicle route. This is achieved by using a processor or a computing device to calculate a remaining number of refuse containers to be collected on the refuse collection vehicle route and to compare the remaining number of refuse containers to be collected to a planned number of refuse containers to be collected. Moreover, the processor or the computing device can determine if the planned number of refuse containers to be collected exceeds the remaining number of refuse containers to be collected and consequently, can restrict vehicle body functions when the planned number of refuse containers to be collected exceeds the remaining number of refuse containers to be collected.

Thus, in some implementations, the systems, methods, and refuse collection vehicles of the present disclosure can advantageously manage and optimize battery usage to aid in the completion of a refuse vehicle collection route. Furthermore, in some implementations, the systems, methods, and refuse collection vehicles of the present disclosure can enable a customer to monitor the performance and efficiency of the refuse collection vehicle during a route. For example, a customer can track and compare the total time to complete a given route by different operators.

It is appreciated that methods in accordance with the present specification may include any combination of the aspects and features described herein. That is, methods in accordance with the present specification are not limited to the combinations of aspects and features specifically described herein, but also include any combination of the aspects and features provided.

The details of one or more implementations of the subject matter described in this disclosure are set forth in the accompanying drawings and the description below. Other features, objects, and advantages of the subject matter will be apparent from the description and drawings, and from the claims.

### DESCRIPTION OF DRAWINGS

FIG. 1 depicts an example system for collecting refuse including a refuse collection vehicle equipped with an electric body.

FIG. 2 depicts an example method for calculating battery usage of a refuse collection vehicle using the system of FIG. 1.

FIG. 3 depicts an example method for calculating a remaining number of refuse containers to be collected on a refuse collection vehicle route using the system of FIG. 1.

FIG. 4 depicts an example method for restricting certain electric vehicle body functions using the system of FIG. 1.

FIG. 5 is a schematic illustration of an example control system or controller for the refuse collection vehicles of the disclosure.

### DETAILED DESCRIPTION

The refuse collection vehicles, systems, and methods of the present disclosure feature processors and/or computing devices to monitor and determine the capacity of a battery of a refuse collection vehicle in real time and perform certain actions (e.g., restrict vehicle body functions, determine and/or predict route completion, etc.) as a result. Furthermore, the processors and/or computing devices of the refuse collection vehicles described herein calculate the number of refuse containers that can be collected in a refuse collection route (i.e., the number of “picks”) based on the determined capacity of the battery in real time.

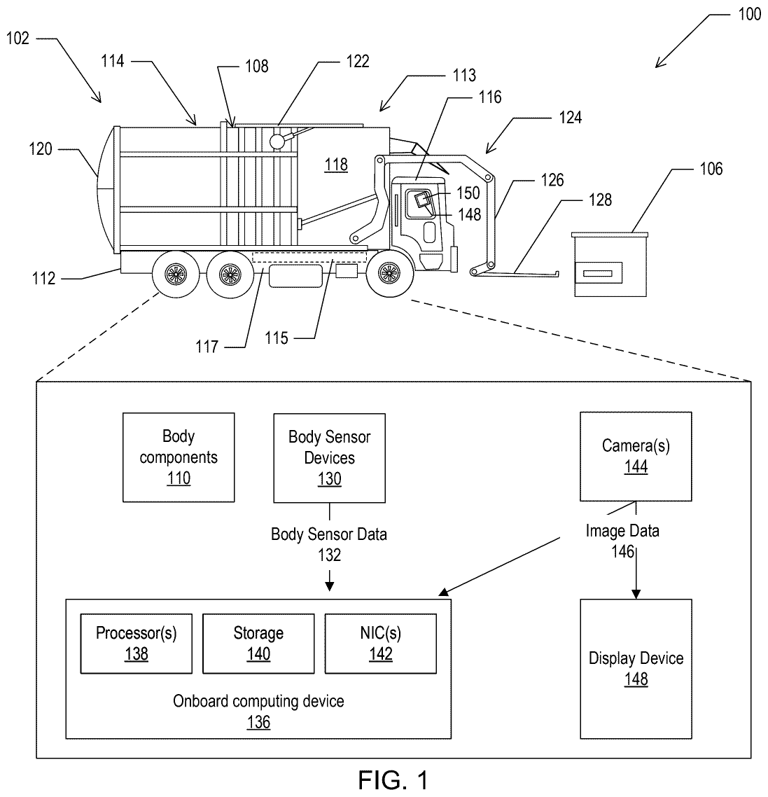

FIG. 1 illustrates an example system 100 for the collection of refuse in accordance with the disclosed embodiments. The system 100 includes a vehicle 102 and one or more onboard computing devices 136 coupled to the vehicle 102. The vehicle 102 can be a refuse collection vehicle that operates to collect and transport refuse. The refuse collection vehicle can also be described as a garbage collection vehicle or garbage truck. The vehicle 102 can be configured to lift a container 106 that contains refuse, and empty the refuse in the container 106 into a hopper 108 of the vehicle 102, to enable transport of the refuse to a collection site, compacting of the refuse, and/or other refuse handling activities. The vehicle 102 can also handle containers in other ways, such as by transporting the containers to another site for emptying.

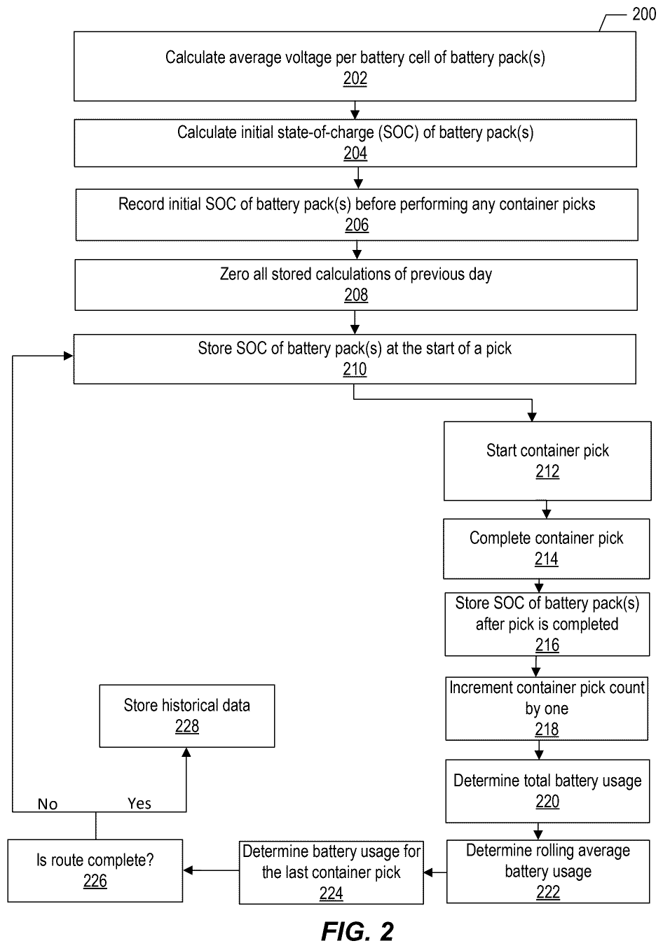

The vehicle 102 can include various body components 110 that are appropriate for the particular type of vehicle. For example, the vehicle 102 is depicted as a front-loading refuse collection vehicle in FIG. 1 and includes a vehicle body 113 that is an all-electric vehicle body or a partially-electric vehicle body. The vehicle body 113 includes various body components 110 such as a chassis 112, a storage body 114 coupled to a back portion of the chassis 112, and a cab 116 coupled to a front portion of the chassis 112. The storage body 114 includes a plurality of panels 118, a tailgate 120, and a hopper cover 122. The hopper 108 is defined by the panels 118, the tailgate 120, and the hopper cover 122 and includes a compartment that receives the collected refuse. The hopper cover 122 is configured to cover the opening of the hopper 108. As shown in FIGS. 1 and 2, the storage body 114 and the hopper 108 extend rearward of the cab 116. The vehicle 102 includes a lift assembly 124 further including a pair of opposing lift arms 126 and a pair of opposing forks 128. The pair of lift arms 126 and the pair of forks 128 extend forward of the cab 116.

Some of the body components 110 can be electrically-actuated. For example, the vehicle body 113 can include an electrically-actuated tailgate 120 to open and close (and optionally lock) the tailgate, an electrically-actuated refuse loading assembly (e.g., an electrically-actuated front-loading refuse collection vehicle, a side-loading refuse collection vehicle loader, or a rear-loading refuse collection vehicle), and an electrically-actuated refuse packing assembly configured transfer refuse from the hopper 108 and to compact the refuse in the storage body 114. The packing assembly may be further configured to eject refuse from the storage body 114 when the tailgate 120 is open. Other systems requiring electrical power may include, for example, vehicle and work lighting, the onboard computer device 136 and camera(s) 144 that are configured to generate image data 146.

The vehicle body 113 may further include an electrical power source such as one or more battery packs 115 that may be rechargeable. In some embodiments, the battery packs 115 do not provide electrical power to at least one of the tailgate 120, a packer, or an auger. In some embodiments, the electrical power required by the packer and/or auger is averaged with a rolling average battery usage. In some embodiments, the battery packs 115 include a first battery pack that provides electrical power to the vehicle body 113 and a second battery pack that provides electrical power to the chassis 112 of the vehicle 102. In some embodiments, the vehicle 102 includes a battery pack that provides electrical power to both the vehicle body 113 and the chassis 112 of the vehicle 102. In some embodiments, the operator can choose whether the vehicle body 113 and the chassis 112 of the vehicle 102 share a battery pack. For example, the option to share a battery pack is displayed on a screen of a display device of the vehicle 102. The battery pack(s) 115 include one or more battery cells and may include substantially any suitable battery system, including but not limited to, nickel batteries, lithium batteries, and the like. The battery pack(s) 115 may be deployed on any suitable location on the vehicle body 113. The battery pack(s) 115 may be advantageously deployed on the underside of the vehicle body 113, for example, between adjacent frame rails 117, to lower the center of gravity of the vehicle 102. In other examples, battery pack(s) 115 can be mounted on the vehicle body 113. In yet another example, the battery pack(s) 115 can be mounted on the chassis 112.

The disclosed embodiments are not limited regarding the battery type or deployment in the vehicle body 113. For example, the battery pack(s) 115 can be traction batteries. In some implementations, the battery pack(s) 115 can be lithium ion batteries. Moreover, while not depicted, it will be understood that the vehicle 102 may further include an alternator electrically coupled with and configured to recharge the one or more battery pack(s) 115.

The disclosed refuse vehicle embodiments may include vehicles including a natural gas-powered internal combustion engine and an all-electric body. In some implementations, the disclosed embodiments may include an all-electric vehicle including an electrically powered propulsion system (an electric motor) and electrically actuated body systems. In such embodiments the propulsion system and the body systems may receive power from the same electrical power source (e.g., located on the chassis 112) or from dedicated power sources (e.g., a first power source on the chassis 112 and a second power source in the vehicle body 113). The disclosed embodiments are expressly not limited in this regard.

It will be understood that the disclosed embodiments are not limited to any particular type or style of refuse vehicle. The vehicle may include a sanitation truck, a recycling truck, a garbage truck, a waste collection truck, etc. In FIG. 1, the depicted vehicle 102 is configured as a front-loading refuse collection vehicle; including an electrically-actuated lift assembly 124 configured to load refuse into the hopper 108 from alongside the vehicle 102. The disclosed embodiments are, of course, not limited in regard to any refuse loading configuration.

For example, while not depicted on FIG. 1, the vehicle 102 may be an all-electric or partially-electric side-loading refuse collection vehicle with an automated side loader (ASL) (e.g., a lift assembly that extends from a side of the storage body 114). A vehicle with an ASL may include body components 110 involved in the operation of the ASL, such as an arm and/or grabbers as well as other body components, such as a pump, a tailgate, a packer, and so forth. In some examples, the vehicle 102 may be a side-loading refuse collection vehicle without a lift assembly. In some embodiments, the vehicle 102 may be an all-electric or partially electric rear-loading refuse collection vehicle that may include body components 110, such as a pump, blade, tipper, and so forth. A front-loading refuse collection vehicle, such as the example shown in FIG. 1, may include body components 110, such as a pump, tailgate, packer, fork assembly, commercial grabbers, and so forth. Body components 110 may also include other types of components that operate to bring garbage into a hopper of a refuse collection vehicle, compress and/or arrange the garbage in the refuse collection vehicle, and/or expel the garbage from the refuse collection vehicle.

It will further be understood that the particular electrically actuated body systems employed by a refuse collection vehicle may depend on the type and configuration of the refuse collection vehicle. For example, the vehicle 102 depicted on FIG. 1 includes a front-loading lift assembly 124 and may include an electrically-actuated pair of forks 128 (configured to be received in fork pockets of the container 106 to enable the lifting of the container 106) and an electrically-actuated pair of lift arms 126 (configured to move the pair of forks 128 inwardly and outwardly with respect to the vehicle body 113 and up and down with respect to a ground surface).

The vehicle 102 can include any number of body sensor devices 130 that sense body component(s) 110 and generate body sensor data 132 describing the operation(s) and/or the operational state of various body components 110. The body sensor devices 130 may be arranged in the body components 110, or in proximity to the body components 110, to monitor the operations of the body components 110. The body sensor devices 130 emit signals that include the body sensor data 132 describing the body component operations, and the signals may vary appropriately based on the particular body component being monitored. The body sensor devices 130 can be provided on the storage body 114 of the vehicle 102 to evaluate cycles and/or other parameters of various body components 110. For example, as described in further detail herein, the body sensor devices 130 can detect and/or measure the particular position and/or operational state of body components such a lift arm, a fork assembly, and so forth.

The body sensor devices 130 can include, but are not limited to, an analog sensor, a digital sensor, a Controller Area Network (CAN) bus sensor, a magnetostrictive sensor, a radio detection and ranging (RADAR) sensor, a light detection and ranging (LIDAR) sensor, a laser sensor, an ultrasonic sensor, an infrared (IR) sensor, a stereo camera sensor, a three-dimensional (3D) camera, in-cylinder sensors, or a combination thereof. In some implementations, the body sensor devices 130 may be incorporated into the various body components 110. Alternatively, the body sensor devices 130 may be separate from the body components 110.

One or more body sensor devices 130 can be situated to determine the state and/or detect the operations of the body components 110. In some embodiments, the vehicle 102 includes one or more body sensor devices 130 that are arranged to detect the position of the pair of lift arms 126 and/or the pair of forks 128. For example, the body sensor device(s) 130 can provide data about the current position of the pair of lift arms 126 and/or the pair of forks 128 throughout a cycle to dump refuse from the container 106 into the hopper 108 of the vehicle 102. In some implementations, the body sensor device(s) 130 are located in one or more cylinders of the vehicle 102. In some examples, a first body sensor device 130 is located inside a cylinder used for raising the pair of lift arms 126 and a second body sensor device 130 is located inside a cylinder used for moving the pair of forks 128. In some implementations, a body sensor device 130 is located on the outside of a housing containing the cylinder coupled to a lift arm 126. In some examples, a body sensor device 130 is an in-cylinder, magnetostrictive sensor.

In some implementations, the body sensor data 132 may be communicated from the body sensor devices 130 to the onboard computing device 136 in the vehicle 102. In some instances, the onboard computing device 136 is an under-dash device (UDU), and may also be referred to as the “gateway.” Alternatively, the onboard computing device 136 may be placed in some other suitable location in or on the vehicle 102. The body sensor data 132 may be communicated from the body sensor devices 130 to the onboard computing device 136 over a wired connection (e.g., an internal bus) and/or over a wireless connection. In some implementations, a Society of Automotive Engineers J1939 standard bus, in conformance with International Organization of Standardization (ISO) standard 11898, connects the various the body sensor devices 130 with the onboard computing device 136. In some implementations, a Controller Area Network (CAN) bus connects the various the body sensor devices 130 with the onboard computing device 136. For example, a CAN bus in conformance with ISO standard 11898 can connect the body sensor devices 130 with the onboard computing device 136. In some implementations, the body sensor data 132 digitize the signals that communicate the body sensor data 132 before sending the signals to the onboard computing device 136 if the signals are not already in a digital format.

The analysis of the body sensor data 132 can be performed at least partly by the onboard computing device 136, e.g., by processes that execute on the processor(s) 138. For example, the onboard computing device 136 can execute processes that perform an analysis of the body sensor data 132 to determine the current position of the body components 110, such as the lift arm position or the fork assembly position. In some implementations, an onboard program logic controller or an onboard mobile controller perform analysis of the body sensor data 132 to determine the current position of the body components 110.

The onboard computing device 136 can include one or more processors 138 that provide computing capacity, data storage 140 of any suitable size and format, and one or more network interface controller(s) (NIC(s)) 142 that facilitate communication of the onboard computing device 136 with other device(s) over one or more wired or wireless networks.

In some implementations, the vehicle 102 includes a body controller that manages and/or monitors various body components of the vehicle 102. The body controller of the vehicle 102 can be connected to multiple sensors in the storage body 114 of the vehicle 102. The body controller can transmit one or more signals over the J1939 network, or other wiring on the vehicle 102, when the body controller senses a state change from any of the sensors. These signals from the body controller can be received by the onboard computing device 136 that is monitoring the J1939 network.

In some implementations, the onboard computing device 136 is a multi-purpose hardware platform. The onboard computing device 136 can include a under dash unit (UDU) and/or a window unit (WU) (e.g., camera) to record video and/or audio operational activities of the vehicle 102. The onboard computing device hardware subcomponents can include, but are not limited to, one or more of the following: a central processing unit (CPU), a memory or data storage unit, a CAN interface, a CAN chipset, NIC(s) such as an Ethernet port, USB port, serial port, I2c lines(s), and so forth, I/O ports, a wireless chipset, a global positioning system (GPS) chipset, a real-time clock, a micro SD card, an audio-video encoder and decoder chipset, and/or external wiring for CAN and for I/O. The onboard computing device 136 can also include temperature sensors, battery and ignition voltage sensors, motion sensors, CAN bus sensors, an accelerometer, a gyroscope, an altimeter, a GPS chipset with or without dead reckoning, and/or a digital CAN interface (DCI). The DCI cam hardware subcomponent can include the following: a CPU, memory, CAN interface, CAN chipset, Ethernet port, USB port, serial port, I2c lines, I/O ports, a wireless chipset, a GPS chipset, a real-time clock, and external wiring for CAN and/or for I/O. In some implementations, the onboard computing device 136 is a smartphone, tablet computer, and/or other portable computing device that includes components for recording video and/or audio data, processing capacity, transceiver(s) for network communications, and/or sensors for collecting environmental data, telematics data, and so forth.

FIG. 2 depicts a flow chart of an example method 200 by which the onboard computing device 136 can calculate a rolling average of the remaining capacity of the battery pack(s) 115 during a refuse vehicle collection route. The voltage in each battery cell of the battery pack(s) 115 is averaged (202) to yield an average voltage per battery cell. In some embodiments, the voltage in each battery cell of the battery pack(s) 115 is measured by a manufacturer of the batteries, and the measurements are transmitted to the onboard computer device 136. In alternative embodiments, the voltage in each battery cell of the battery pack(s) 115 is measured by a manufacturer, an operator, or a device onboard the vehicle 102.

The onboard computing device 136 calculates an initial state-of-charge (SOC) of the battery pack(s) 115 (204). In some embodiments, the onboard computing device 136 calculates the initial SOC by calculating an actual battery voltage span, which is determined by subtracting a minimum battery cell voltage from the average voltage per battery cell determined in step 202. In some embodiments, the minimum battery cell voltage is a predetermined value.

Next, the onboard computing device 136 calculates the initial SOC by dividing the actual battery voltage span by the number of volts per 1% SOC. The number of volts per 1% SOC is determined by dividing a total battery voltage span (e.g., the battery's minimum cell voltage subtracted from the battery's maximum cell voltage) by 100. The total battery voltage span is the total voltage span of a battery cell that is fully charged (e.g., charged to 100% of its capacity). In some embodiments, the number of volts per 1% SOC is a predetermined value. The onboard computing device 136 then records the initial SOC before the vehicle 102 performs any container picks (e.g., before the vehicle 102 collects any refuse containers on a refuse vehicle collection route) (206). As used herein, the term “pick” or “picks” refers to a refuse container or refuse containers, respectively, being collected by the vehicle 102 on a refuse collection route.

All SOC, voltage, or other battery capacity-related calculations that were previously stored (e.g., from a previous day) in the onboard computing device 136 are then zeroed (208) by the onboard computing device 136. In some embodiments, the SOC, voltage, or other battery capacity-related calculations that were previously stored (e.g., from a previous day) in the onboard computing device 136 are zeroed automatically by the onboard computing device 136.

The onboard computing device 136 stores the SOC of the battery pack(s) 115 (210) prior to collecting a refuse container.

Once the SOC value is stored, the onboard computing device 136 proceeds to start (212) and complete (214) the collection of the refuse container.

The onboard computing device 136 then calculates the SOC of the battery pack(s) 115 after the collection of the refuse container has been completed and stores (216) this SOC value.

Next, the onboard computing device 136 begins to count the number of refuse containers that have been collected by the vehicle 102 and increments its counter by one after each refuse container is collected (218).

The total battery usage after each refuse container is collected is calculated by the onboard computing device 136 (220) by comparing the current SOC of the battery pack(s) 115 to the maximum capacity of the battery pack(s) 115 (e.g., when the battery pack(s) 115 are fully charged or at the start or refuse collection route). For example, the onboard computing device 136 subtracts the current SOC of the battery pack(s) 115 from the maximum capacity of the battery pack(s) 115.

The onboard computing device 136 calculates an estimated battery usage per “pick” (222) by dividing the total battery usage up until that point by the total number of refuse containers that have been collected by the vehicle 102 up until that point. In this example, the estimated battery usage per “pick” is a rolling average battery usage.

The onboard computing device 136 calculates the battery usage for the last refuse container that was collected (224) by subtracting the SOC of the battery pack(s) 115 at the end of the collection of the refuse container, at that point in time, from the SOC of the battery pack(s) 115 at the beginning of the collection of that same refuse container.

The onboard computing device 136 then requests an input from an operator of the vehicle 102 prompting the question of the refuse collection route has been completed (226).

If the operator of the vehicle 102 provides “yes” as an input, the onboard computing device 136 proceeds to store the data (e.g., the average SOC usage and total SOC usage) generated during that day (228). In addition, the onboard computing device 136 proceeds to store the number of “picks” reflected by the counter. In some embodiments, the stored data can be accessed at a later time (e.g., at the start of a new refuse collection route the next day). If the operator of the vehicle 102 provides “no” as an input, the onboard computing device 136 proceeds to step 210 to store the SOC of the battery pack(s) 115 at the start of the collection of a new refuse container.

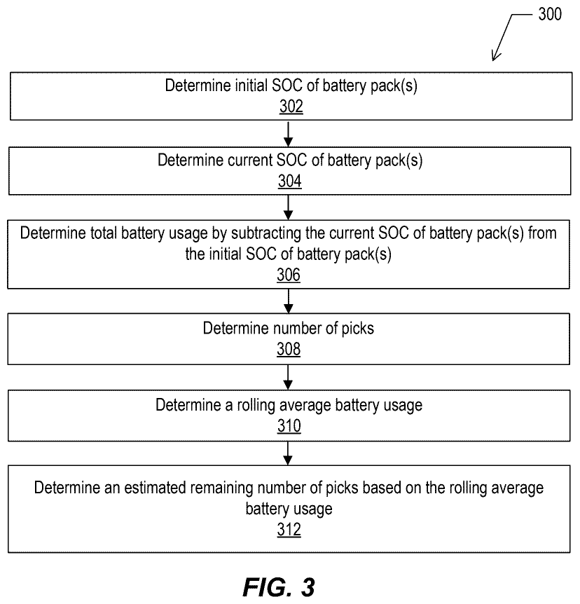

FIG. 3 depicts a flow chart of an example method 300 by which the onboard computing device 136 can determine a remaining number of refuse containers to be collected in a refuse collection route. The onboard computing device 136 begins by determining an initial SOC of the battery pack(s) 115 (302). In some embodiments, the initial SOC of the battery pack(s) 115 is the SOC of the battery pack(s) before the vehicle 102 collects the first refuse container in the refuse collection route. In some embodiments, the onboard computing device 136 determines an initial SOC of the battery pack(s) 115 by retrieving the initial SOC value from a memory of the computing system of the vehicle 102, as the SOC of the battery pack(s) 115 is recorded and stored before collecting any refuse containers as described by step 206 of method 200.

Next, the onboard computing device 136 determines the current SOC of the battery pack(s) 115 (304). In some embodiments, the onboard computing device 136 determines the current SOC of the battery pack(s) 115 by performing a calculation relating a voltage of the battery pack(s) to the SOC as described in steps 202 and 204 of method 200.

The onboard computing device 136 then determines total battery usage by subtracting the current SOC of the battery pack(s) 115 from the initial SOC of the battery pack(s) 115 (306). In some embodiments, the total battery usage reflects the total charge of the battery pack(s) 115 that has been used since the start of the refuse collection route (e.g., before the vehicle 102 collects the first refuse container in the refuse collection route) up until the point in time when the current SOC of the battery pack(s) 115 is determined in step 304.

Next, the onboard computing device 136 determines the number of “picks” or the number of refuse containers that have been collected by the vehicle 102 (308). In some embodiments, the onboard computing device 136 determines the number of “picks” by retrieving this number from the memory of the computing system of the vehicle 102. As step 218 describes, a container pick counter counts the number of refuse containers that are collected, records this value, and stores it in the memory of the computing system of the vehicle 102.

The onboard computing device 136 then determines a rolling average battery usage (310). In some embodiments, the onboard computing device 136 determines a rolling average battery usage by dividing the total battery usage, determined in step 306, by the number of refuse containers that have been collected by the vehicle 102 that was determined in step 308. In some embodiments, the onboard computing device 136 determines the rolling average battery usage by continuously updating the calculation of the battery usage average to include all the data (e.g., total battery usage and number of “picks”) until a determined time point (e.g., until the most recent time point). In some embodiments, the onboard computing device 136 determines a rolling average battery usage in real time.

Next, the onboard computing device 136 determines an estimated remaining number of refuse containers to be collected based on the rolling average battery usage (312). In some embodiments, the onboard computing device 136 determines the estimated remaining number of refuse containers to be collected by dividing the current SOC of the battery pack(s) 115, determined in step 304, by the rolling average battery usage (e.g., having units such as % SOC per “pick”) that is determined in step 310.

In some embodiments, the onboard computing device 136 further adds a “buffer zone” to the estimated remaining number of refuse containers to be collected. In some embodiments, adding a “buffer zone” is done to provide increased safety and to account for potential variability in the current SOC of the battery pack(s) 115 and the rolling average battery usage.

In some embodiments, the “buffer zone” is a predetermined number or a percentage of the number of refuse containers to be collected that can be added to and/or subtracted from the estimated remaining number of refuse containers to be collected. For example, in some embodiments, the onboard computing device 136 can add and/or subtract a “buffer zone” of 20% (of the estimated remaining number of refuse containers to be collected) to the estimated remaining number of refuse containers to be collected. In some embodiments, the “buffer zone” can range from about 5% to about 30% (e.g., about 5% to about 10%, 5% to about 15%, 5% to about 20%, 5% to about 25%, or 15% to about 30%) of estimated remaining number of refuse containers to be collected.

Alternatively, in some embodiments, the onboard computing device 136 can determine the “buffer zone.” For example, the onboard computing device 136 can calculate an average and standard deviation of the estimated remaining number of refuse containers to be collected. Then, the onboard computing device 136 can use the standard deviation as the “buffer zone” to be added to and/or subtracted from the estimated remaining number of refuse containers to be collected. In some embodiments, the onboard computing device 136 includes more than one standard deviation (e.g., two or three standard deviations) in the “buffer zone.”

In some embodiments, the onboard computing device 136 provides a rolling estimated remaining number of refuse containers to be collected that updates continuously after every “pick.” In some embodiments, the estimated remaining number of refuse containers to be collected provides the operator with an estimate of the number of refuse containers that can be collected by the vehicle 102 with the remaining charge of the battery pack(s) 115 at a determined time point (e.g., at the time point when the current SOC of the battery pack(s) is determined). In some embodiments, the estimated remaining number of refuse containers to be collected is based on the average of refuse containers that have been collected from the start of the refuse collection route until a determined time point (e.g., until the time point when the current SOC of the battery pack(s) is determined).

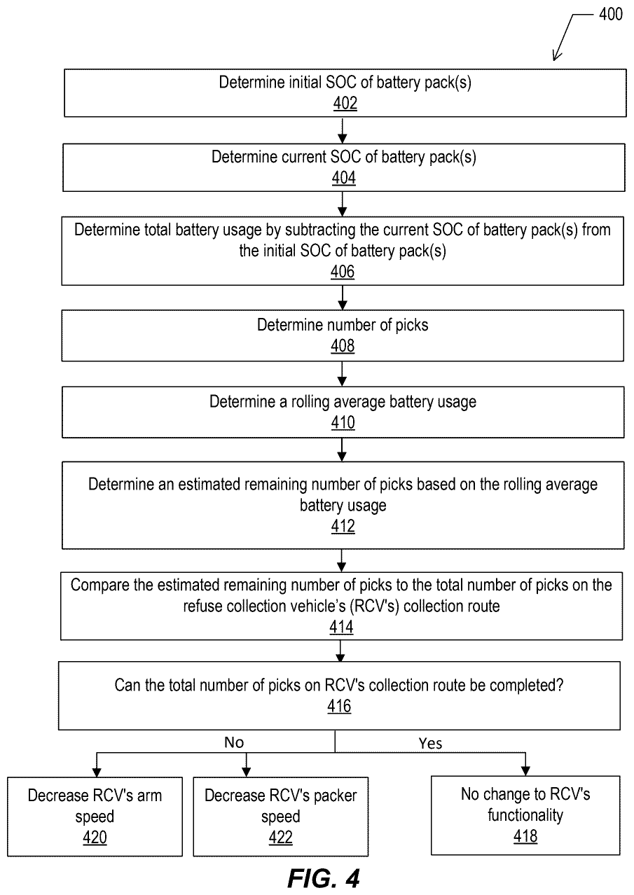

FIG. 4 depicts a flow chart of an example method 400 by which the onboard computing device 136 can determine a remaining capacity of the battery pack(s) 115 and can further restrict certain electric vehicle body functions when the remaining capacity is determined to be insufficient to complete the refuse collection route, thereby optimizing the refuse collection route. Steps 402, 404, 406, 408, 410, and 412 are substantially the same as steps 302, 304, 306, 308, 310, and 312 discussed above. Based on the estimated number of remaining picks, which is determined in step 412, the onboard computing device 136 compares the estimated remaining number of picks to the total number of picks that are planned to be collected on the refuse collection route of the vehicle 102 (414). Based on this comparison, the onboard computing device 136 determines whether the planned number of refuse containers to be collected exceeds the remaining number of refuse containers that can be collected (416). In some embodiments, steps 402-416 are performed in real-time (e.g., during the refuse collection route).

If it is determined that the planned number of refuse containers to be collected does not exceed the estimated remaining number of refuse containers that can be collected based on the remaining battery capacity, then the onboard computing device 136 does not initiate a change to a functionality of the vehicle 102 (418).

If it is determined that the planned number of refuse containers to be collected exceeds the estimated remaining number of refuse containers that can be collected, then the onboard computing device 136 performs operations to restrict certain electric vehicle body functions of the vehicle 102.

For example, the onboard computing device 136 can perform operations to restrict a speed of the electrically-actuated lift assembly 124 (420).

In some examples, the onboard computing device 136 can perform operations to restrict a speed of the electrically-actuated refuse packing assembly (422).

In some embodiments, the onboard computing device 136 can perform operations to restrict the speed of both electrically-actuated lift and refuse packing assemblies. In some embodiments, decreasing the speed of the electrically-actuated lift assembly includes decreasing a speed at which an arm of the electrically-actuated lift assembly 124 is lifted and/or decreasing a speed at which the arm is extended. In some embodiments, the onboard computing device 136 performs operations to shift the arm of the electrically-actuated lift assembly 124 into a low-power mode to conserve power. In some examples, the onboard computing device 136 can perform operations to restrict an actuation of the electrically-actuated refuse packing assembly.

The onboard computing device 136 may use a method that is substantially similar in function in several aspects to the example method 400 discussed above, but can include an alternative method to restrict certain electric vehicle body functions. For example, in some embodiments, the alternative method can include restricting certain electric vehicle body functions when the remaining capacity falls below a threshold, instead of when the remaining capacity is determined to be insufficient to collect the planned number of refuse containers. In some embodiments, the threshold is determined adaptively. In some embodiments, the threshold can be about 10% battery capacity, such that the alternative method can include restricting certain electric vehicle body functions when the remaining capacity falls below about 10%. In some embodiments, the threshold can be about 20% battery capacity, such that the alternative method can include restricting certain electric vehicle body functions when the remaining capacity falls below about 20%. In some implementations, the threshold can be about 10% to about 20% battery capacity.

Among other things, the techniques described herein include a method for detecting outliers in the amount of battery usage per refuse container that is collected by the vehicle 102. In some embodiments, the method can use a machine learning (ML) model. ML models or techniques are also referred to herein as artificial intelligence (AI). The machine learning techniques described herein can be implemented on at least one computing processor (e.g., the onboard computing device 136 or a cloud computing server) and/or at least one hardware accelerator coupled to the at least one computing processor.

For example, in some embodiments, the method includes the following steps. The method includes receiving a plurality of data points obtained from the vehicle 102 during the refuse collection route. In some embodiments, the plurality of data points include the amount of charge of the battery pack(s) 115 that is used to collect each refuse container during the refuse collection route. In some embodiments, the plurality of data points have units such as % SOC per “pick.” In some embodiments, the amount of charge is determined by retrieving the rolling average battery usage at the time of the collection of each refuse container during the refuse collection route. In some embodiments, the plurality of data points include the amount of power used to collect each refuse container during the refuse collection route.

Next, the method includes comparing the amount of charge of the battery pack(s) 115 that is used to collect each refuse container to one or more thresholds (e.g., a maximum threshold and a minimum threshold). In some embodiments, the maximum threshold is about at least 10% higher than the average amount of charge of the battery pack(s) 115 that is used to collect each refuse container. In some embodiments, the minimum threshold is about at least 10% lower than the average amount of charge of the battery pack(s) 115 that is used to collect each refuse container. In some embodiments, the average amount of charge of the battery pack(s) 115 that is used to collect each refuse container is determined by averaging the plurality of data points of one refuse collection route. In some embodiments, the average amount of charge of the battery pack(s) 115 that is used to collect each refuse container is determined by averaging the plurality of data points of two or more refuse collection routes (e.g., the refuse collection routes performed in one week, one month, two to six months, or six months to a year). In some embodiments, the maximum and minimum thresholds are determined by calculating a standard deviation of the plurality of data points. For example, in some embodiments, the maximum and minimum thresholds can be three standard deviations above and below the average, respectively. In some embodiments, the ML model uses a z-score to determine the maximum and minimum thresholds. In some embodiments, the ML model uses an interquartile range to determine the maximum and minimum thresholds. In some embodiments, the ML model uses percentiles to determine the maximum and minimum thresholds. For example, in some embodiments, the ML model can use a custom range that accommodates all data points that lie anywhere between a minimum and a maximum percentile of the dataset and can filter the data points using the minimum and maximum limits defined by the custom range.

Next, the method includes identifying each data point as either an outlier or not an outlier based on the comparison to the one or more thresholds. For example, the data point is identified as an outlier if it exceeds the maximum threshold or if it is under the minimum threshold. Such classification is also referred to as binary classification. In one implementation, the identification of each data point can be performed manually. In alternate implementations, the identification of each data point can be performed by the computing processor (e.g., the onboard computing device 136 or a cloud computing server) in an automated fashion. For example, the computing processor can implement a statistical algorithm to calculate the average of the plurality of data points and determine the maximum and minimum thresholds (e.g., by calculating a standard deviation of the plurality of data points or using any of the aforementioned methods). The algorithm can then identify and classify an outlier if it exceeds the maximum threshold or if it is under the minimum threshold.

Next, the method includes training the ML model, based on the previous identifying step, using the plurality of data points. As the received data points have been classified, the actual output of the sample inputs (i.e., the received data points) are known. The machine learning model may, however, generate a different output. The difference between the known, correct output for the sample inputs and the actual output of the machine learning model is referred to as a training error. The purpose of the training of the ML model is to reduce the training error until the model produces an accurate prediction for the training set. Training is the process of learning (i.e., determining) weights and bias values that the ML model should apply when inferences are made while minimizing the error (i.e., inaccuracy) in making predictions. In some implementations, errors are minimized and biases are reduced by performing tests and comparisons between the ML model and the prototype.

Next, the method includes optimizing the ML model by performing learning against a validation set (e.g., a test set). The training set is a group of sample inputs to be fed into the ML model (e.g., a neural network model) to train the ML model, and the validation set is a group of inputs and corresponding outputs that are used to determine the accuracy of the ML model when the ML model is being trained. While the plurality of data points are described as being received from the vehicle 102, in other implementations the plurality of data points can be received from a two or more vehicles 102.

The computing processor can fine-tune (e.g., improve the accuracy of the parameters of the trained machine learning model by performing learning using the validation set. Such fine-tuning can also be referred to as optimization of the machine learning model. The fine-tuning (or optimization) can implement various optimization algorithms, such as gradient descent, stochastic gradient descent, mini-batch gradient descent, momentum, adaptive moment estimation (also referred to as Adam), and/or the like. The computing processor can implement an algorithm based on the computational aspects (e.g., computational architecture and structure) of the computing processor. The gradient descent algorithm advantageously involves simple computations and is easy to implement and easy to understand. The stochastic gradient descent algorithm advantageously involves frequent updates of model parameters and thus converges in less time, and requires less memory as there is no need to store values of loss functions. The mini-batch gradient descent algorithm advantageously frequently updates the model parameters, has less variance, and requires a medium amount of memory. The momentum algorithm advantageously reduces the oscillations and high variance of the parameters, and converges faster than gradient descent. The Adam algorithm advantageously is fast and converges rapidly, rectifies vanishing learning rate, and has a high variance.

Thus, in the training phase, a known data set is put through an untrained machine learning model (e.g., untrained neural network), the results are compared with known results of the data set, and the framework reevaluates the error value and updates the weight of the data set in the layers of the neural network based on accuracy of the value. This reevaluation advantageously adjusts the neural network to improve the performance of the specific task—i.e., the classification task of classifying a data point as being an outlier or not an outlier—that the neural network is learning.

The optimized ML model is then used to generate a prediction for an estimated remaining number of refuse containers to be collected based on the available battery SOC and based on the plurality of data points that have been classified and filtered (e.g., by excluding the outliers) by the ML model. The prediction thus prevents the outliers from skewing the estimated remaining number of refuse containers to be collected. For example, in some embodiments, the prediction prevents a heavier load that exceeds the maximum threshold and is collected to skew the estimated remaining number of “picks” based on the available SOC of the battery pack(s) 115. This advantageously provides the operator with a more accurate estimate to complete the refuse collection route while maximizing energy usage of the battery pack(s) 115. Unlike the training phase, the deployment phase does not reevaluate or adjust the layers of the neural network based on the results, and instead the prediction applies knowledge from the trained neural network model and a uses that model to predict the estimated remaining number of refuse containers to be collected. Therefore, when a new set of one or more data points is input through the trained neural network, the neural network model outputs a prediction of estimated remaining number of refuse containers to be collected based on the predictive accuracy of the neural network.

Referring back to FIG. 1, the vehicle 102 includes a display device 148 inside the cab 116 of the vehicle 102. The display device 148 includes a screen 150. In some implementations, in response to determining that the remaining battery capacity falls below the threshold or that the planned number of refuse containers to be collected exceeds the remaining number of refuse containers that can be collected, the onboard computing device 136 can cause a visual alert and/or an audible alert to be generated that alerts an operator of the vehicle 102 to the status of the remaining battery capacity. In some implementations, a visual alert is displayed on the screen 150 of the display device 148 in response to determining that the remaining battery capacity falls below the threshold or that the planned number of refuse containers to be collected exceeds the remaining number of refuse containers that can be collected. In some embodiments, the onboard computing device 136 is configured to display image data including the SOC of the battery pack(s) 115 and/or the remaining battery capacity. In some embodiments, the onboard computing device 136 is configured to display image data including the remaining number of refuse containers that can be collected on a refuse collection route. In some examples, the onboard computing device 136 is configured to transmit the image data to one or more remote computing devices for display.

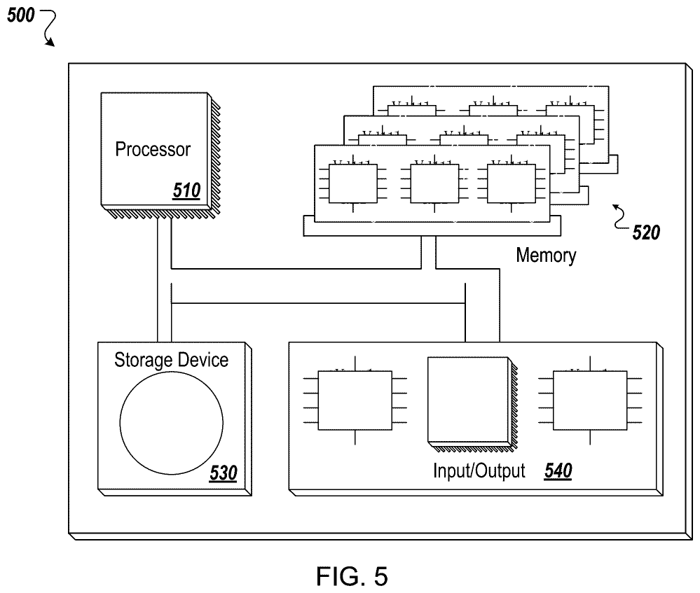

FIG. 5 depicts an example computing system, according to implementations of the present disclosure. The system 500 may be used for any of the operations described with respect to the various implementations discussed herein. For example, the system 500 may be included, at least in part, in one or more of the onboard computing device 136, and/or other computing device(s) or system(s) described herein. The system 500 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 500 includes a processor 510, a memory 520, a storage device 530, and an input/output device 540. Each of the components 510, 520, 530, and 540 are interconnected using a system bus. The processor 510 is capable of processing instructions for execution within the system 500. The processor may be designed using any of a number of architectures. For example, the processor 510 may be a CISC (Complex Instruction Set Computers) processor, a RISC (Reduced Instruction Set Computer) processor, or a MISC (Minimal Instruction Set Computer) processor.

In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device.

The input/output device 540 provides input/output operations for the system 500. In one implementation, the input/output device 540 includes a joystick. In some implementations, the input/output device 540 includes a display unit for displaying graphical user interfaces. For example in some implementations, the input/output device 540 is a display device that includes one or more buttons and/or a touchscreen for receiving input from a user. In some implementations, the input/output device 540 includes a keyboard and/or a pointing device. In some implementations, the input/output device 540 is located within a cab of a refuse collection vehicle (e.g., within cab 116 of vehicle 102). For example, the input/output device 540 can be attached to or incorporated within a dashboard inside the cab of a refuse collection vehicle.

While certain embodiments have been described, other embodiments are possible.

For example, while the method of determining the number of remaining refuse containers to be collected has been described as including the steps of dividing the current SOC of the battery pack(s) 115 by the rolling average battery usage, other methods of determining the remaining number of “picks” in a refuse collection route are possible. For example, in some embodiments, the method of determining the estimated remaining number of remaining refuse containers to be collected in a refuse collection route includes the onboard computing device 136 determining the charge of the battery pack(s) 115 that is used per “pick” for every refuse container that is collected and then calculating an average. In some embodiments, once the average charge per “pick” is calculated, the onboard computing device 136 determines an estimated remaining number of remaining refuse containers to be collected by dividing the current SOC of the battery pack(s) 115 by the average charge per “pick.” In some embodiments, the onboard computing device 136 determines the charge of the battery pack(s) 115 by measuring the amount of energy of the battery pack(s) 115 that is used per refuse container that is collected. In some embodiments, the amount of energy is measured in kilowatt-hours (kWh). In some embodiments, the amount of energy is calculated based on voltage measurements. In some implementations, the voltage measurements of each battery cell of the battery pack(s) 115 are provided by the manufacturer of the batteries. In alternative embodiments, the voltage measurements of each battery cell of the battery pack(s) 115 are measured by an operator or by a device onboard the vehicle 102. In some embodiments, this alternative method of determining the estimated remaining number of remaining refuse containers to be collected can advantageously exclude the contribution of additional vehicle components (e.g., the electrically-actuated refuse packing assembly or chassis) to the depletion of battery power and the rolling average battery usage. Furthermore, in some embodiments, this alternative method of determining the estimated remaining number of remaining refuse containers to be collected can advantageously remain unbiased to a battery pack or cell having a variable rate of discharge. For example, if a battery pack(s) discharges at a variable rate (e.g., faster or slower than average), the rolling average battery usage would be affected, whereas determining the average charge of the battery pack(s) 115 that is used per “pick” for every refuse container that is collected would not be affected.

Although the following detailed description contains many specific details for purposes of illustration, it is understood that one of ordinary skill in the art will appreciate that many examples, variations and alterations to the following details are within the scope and spirit of the disclosure. Accordingly, the exemplary implementations described in the present disclosure and provided in the appended figures are set forth without any loss of generality, and without imposing limitations on the claimed implementations.

Although the present implementations have been described in detail, it should be understood that various changes, substitutions, and alterations can be made hereupon without departing from the principle and scope of the disclosure. Accordingly, the scope of the present disclosure should be determined by the following claims and their appropriate legal equivalents.

The singular forms “a,” “an,” and “the” include plural referents, unless the context clearly dictates otherwise.

As used in the present disclosure and in the appended claims, the term “state-of-charge” or “SOC” is defined as the ratio of the available battery pack(s) capacity or charge and the maximum possible capacity or charge that can be stored in the battery(s). In some examples, a fully charged battery pack(s) has an SOC of 100% while a fully discharged battery pack(s) has an SOC of 0%.

As used in the present disclosure, the term “pick(s)” is defined as the collection of a refuse container by the vehicle 102 in a refuse collection route.

As used in the present disclosure and in the appended claims, the words “comprise,” “has,” and “include” and all grammatical variations thereof are each intended to have an open, non-limiting meaning that does not exclude additional elements or steps.

As used in the present disclosure, terms such as “first” and “second” are arbitrarily assigned and are merely intended to differentiate between two or more components of an apparatus. It is to be understood that the words “first” and “second” serve no other purpose and are not part of the name or description of the component, nor do they necessarily define a relative location or position of the component. Furthermore, it is to be understood that the mere use of the term “first” and “second” does not require that there be any “third” component, although that possibility is contemplated under the scope of the present disclosure.

Ranges may be expressed herein as from “about” one particular value and/or to “about” another particular value. When such a range is expressed, another embodiment includes from the one particular value and/or to the other particular value. The use of the term “about” in this disclosure, when used to describe a numerical range or value, references a margin within +5% of the stated value or range. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

What is claimed is:

1. A refuse collection vehicle, comprising:
a chassis;
a cab coupled to a front portion of the chassis;
an electric vehicle body coupled to the chassis rearward of the cab, the electric vehicle body including one or more electrically powered body systems;
at least one rechargeable battery pack configured to provide electric power to the body systems; and
a computing device configured to perform operations comprising:
calculating a state-of-charge of the at least one rechargeable battery pack based on a voltage of the at least one rechargeable battery pack,
determining a remaining capacity of the at least one rechargeable battery pack, and
restricting certain electric vehicle body functions when the remaining capacity falls below a threshold.

2. The refuse collection vehicle of claim 1, wherein the electric vehicle body includes one or more of an electrically-actuated tailgate, an electrically-actuated lift assembly, and an electrically-actuated refuse packing assembly.

3. The refuse collection vehicle of claim 2, wherein restricting certain electric vehicle body functions comprises decreasing a speed of one or both of the electrically-actuated lift assembly and the electrically-actuated refuse packing assembly.

4. The refuse collection vehicle of claim 3, wherein decreasing the speed of the electrically-actuated lift assembly comprises one or both of decreasing a speed at which an arm of the electrically-actuated lift assembly is lifted and decreasing a speed at which the arm is extended.

5. The refuse collection vehicle of claim 1, wherein the computing device is configured to generate a visual alert or an audible alert when the remaining capacity falls below the threshold.

6. The refuse collection vehicle of claim 1, wherein the threshold is determined adaptively.

7. The refuse collection vehicle of claim 1, wherein the computing device is an onboard computing device of the refuse collection vehicle.

8. The refuse collection vehicle of claim 1, wherein the refuse collection vehicle comprises a display device within the cab, and the computing device is configured to display image data comprising one or both of the state-of-charge of the at least one rechargeable battery pack, and the remaining capacity of the at least one rechargeable battery pack.

9. The refuse collection vehicle of claim 8, wherein the computing device is configured to transmit the image data to one or more remote computing devices for display.

10. The refuse collection vehicle of claim 1, wherein the computing device is configured to perform operations further comprising: based on the remaining capacity, calculating a remaining number of refuse containers that can be collected on a refuse collection route.

11. The refuse collection vehicle of claim 10, wherein the computing device is configured to perform operations further comprising: comparing the remaining number of refuse containers that can be collected to a planned number of refuse containers to be collected, determining if the planned number of refuse containers to be collected exceeds the remaining number of refuse containers that can be collected, and restricting certain electric vehicle body functions when the planned number of refuse containers to be collected exceeds the remaining number of refuse containers that can be collected.

12. The refuse collection vehicle of claim 11, wherein the computing device is configured to generate a visual alert or an audible alert when the planned number of refuse containers to be collected exceeds the remaining number of refuse containers that can be collected.

13. The refuse collection vehicle of claim 12, wherein the refuse collection vehicle comprises a display device within the cab, and the computing device is configured to display image data comprising the remaining number of refuse containers that can be collected on a refuse collection route.

14. The refuse collection vehicle of claim 1, wherein the at least one rechargeable battery pack is mounted on the electric vehicle body.

15. The refuse collection vehicle of claim 1, wherein the at least one rechargeable battery pack is mounted on the chassis.

16. The vehicle of claim 1, wherein the at least one rechargeable battery pack is a traction battery.

17. A system comprising:
a refuse collection vehicle, comprising:
a chassis;
a cab coupled to a front portion of the chassis;
an electric vehicle body coupled to the chassis rearward of the cab, the electric vehicle body including one or more electrically powered body systems; and
at least one rechargeable battery pack configured to provide electric power to the body systems; and
at least one processor communicably coupled to the electric vehicle body and the at least one rechargeable battery pack, the at least one processor configured to perform operations comprising:
calculating a state-of-charge of the at least one rechargeable battery pack based on a voltage of the at least one rechargeable battery pack,
determining a remaining capacity of the at least one rechargeable battery pack, and
restricting certain electric vehicle body functions when the remaining capacity falls below a threshold.

18. A computer-implemented method performed by at least one processor, the computer-implemented method comprising:
calculating, by the at least one processor, a state-of-charge of at least one rechargeable battery pack of a refuse collection vehicle based on a voltage of the at least one rechargeable battery pack;
determining, by the at least one processor, a remaining capacity of the at least one rechargeable battery pack; and
restricting, by the at least one processor, certain functions of an electric vehicle body of the refuse collection vehicle when the remaining capacity falls below a threshold.

19. The computer-implemented method of claim 18, wherein the electric vehicle body includes one or more of an electrically-actuated tailgate, an electrically-actuated lift assembly, and an electrically-actuated refuse packing assembly.

20. The computer-implemented method of claim 19, wherein restricting certain electric vehicle body functions comprises decreasing a speed of one or both of the electrically-actuated lift assembly and the electrically-actuated refuse packing assembly.

21. The computer-implemented method of claim 20, wherein decreasing the speed of the electrically-actuated lift assembly comprises one or both of decreasing a speed at which an arm of the electrically-actuated lift assembly is lifted and decreasing a speed at which the arm is extended.

22. The computer-implemented method of claim 18, further comprising generating, by the at least one processor, a visual alert or an audible alert when the remaining capacity falls below the threshold.

23. The computer-implemented method of claim 18, wherein the threshold is determined adaptively.

24. The computer-implemented method of claim 18, further comprising, displaying, by the at least one processor, on a display device within a cab of the refuse collection vehicle, image data comprising one or both of the state-of-charge of the at least one rechargeable battery pack and the remaining capacity of the at least one rechargeable battery pack.

25. The computer-implemented method of claim 24, transmitting, by the at least one processor, the image data to one or more remote processors for display.

26. The computer-implemented method of claim 18, further comprising, calculating, by the at least one processor, based on the remaining capacity, a remaining number of refuse containers that can be collected on a refuse collection route.

27. The computer-implemented method of claim 26, further comprising comparing, by the at least one processor, the remaining number of refuse containers that can be collected to a planned number of refuse containers to be collected, determining, by the at least one processor, if the planned number of refuse containers to be collected exceeds the remaining number of refuse containers that can be collected, and restricting, by the at least one processor, certain electric vehicle body functions when the planned number of refuse containers to be collected exceeds the remaining number of refuse containers that can be collected.

28. The computer-implemented method of claim 27, further comprising generating, by the at least one processor, a visual alert or an audible alert when the planned number of refuse containers to be collected exceeds the remaining number of refuse containers that can be collected.

29. The computer-implemented method of claim 28, further comprising, displaying, by the at least one processor, on a display device within a cab of the refuse collection vehicle, image data comprising the remaining number of refuse containers that can be collected on a refuse collection route.
